(19) United States
(12) Patent Application Publication
(10) Pub. No.: US 2006/0242232 A1
(43) Pub. Date: Oct. 26, 2006

(54) Automatically limiting requests for additional chat sessions received by a particula user

(75) Inventors: Jessica Murillo, Round Rock, TX (US); Johnny Meng-Han Shieh, Austin, TX (US)

Correspondence Address: Intellectual Property Law Dept.;IBM Corporation, 11400 Burnet Road, Austin, TX, 78758, US

(73) Assignee: International Business Machines Corporation, Armonk, NY (US)

(21) Appl. No.: 11/095,739

(22) Filed: Mar. 31, 2005

(51) Int. Cl. G06F 15/16

(52) U.S. Cl. 709/204

(57) ABSTRACT

A method, system, and program for automatically limiting requests for additional chat sessions received by a particular user are provided. The number of multiple chat sessions concurrently open between a particular user and a separate user from among a first selection of multiple users are detected, wherein the first selection of the multiple users and a remaining selection of the multiple users monitor a presence of the particular user through a presence indicator that indicates whether the particular user is available to participate in an additional chat session. Responsive to the number of concurrently open chat sessions exceeding a threshold for the particular user, updating the presence indicator of the particular user transmitted to the remaining selection of the multiple users to indicate a lack of availability for the additional chat session, but enabling the first selection of the multiple users to continue participating in the already open chat sessions with the particular user.

### BACKGROUND OF THE INVENTION

1. Technical Field

The present invention relates in general to improved chat service and in particular to placing limitations on additional requests for chat sessions with a particular user who is already participating in chat sessions. Still more particularly, the present invention relates to automatically limiting a particular user from receiving additional chat session requests by blocking those users not currently participating in a chat session with the particular user from initiating a new chat session with the particular user.

2. Description of the Related Art

Electronic communications continue to overtake traditional telephone communications. In particular, with the advent of chat communications that provide real-time communication via a network, many businesses now rely on chat based communications to support employee communication. Currently, chat communications are implemented in multiple formats including, but not limited to, chat rooms, instant messaging, and Internet Relay Chat (IRC).

Typically, chat communication users access a chat service, through a communication device, where the chat service facilitates chat communication through one or more of the chat formats. In one example, chat communication users subscribe with chat service providers who may support multiple formats of chat communications. In addition, chat communication users may access a private or local network that includes chat applications for supporting one or more formats of chat communications among network users.

One feature of many chat services is that one user, such as “user A”, may concurrently chat in the different chat formats in multiple independent chat sessions. For example, “user A” may participate in a chat session of a chat room format with “user B” and “user C” and also participate in a chat session of an instant messaging format with “user D”. The user interface, through which “user A” accesses the chat service, may include separate graphical windows to distinguish each chat session.

An important supporting function of chat communications is detection of the “presence” of users to receive and participate in chat sessions. The presence of a user typically indicates the availability of a user to participate in chat communications. Some chat services allow a user to select a presence from multiple types of availability indicators. For example, the user may select from a range of indicators such as “available”, “busy”, “away from my desk”, and “at a meeting.” When a user does not want to participate in or be disturbed by chat communications, but does not want to or cannot log off from the chat service, some chat services allow the user to select an indicator such as “do not disturb” that indicates to the chat service to block all chat communications to the user.

Since a chat service monitors the presence of each user, chat services may also enable each user to designate a selection of other users who are also subscribers to the chat service and enable each user to receive updates of the presence of the selection of other users. Some services refer to this selection of other users as a buddy list. In one example, “user A” designates a buddy list that includes other user identifiers such as “user B”, “user C”, “user D”, “user E”, “manager A”, and “manager B”. In the display interface accessible to “user A”, each of the user identifiers in the buddy list may be separately listed with a graphical indicator of the presence of each identified user.

One disadvantage to chat service is that once a particular user logs on to the chat service, other users both on and off the buddy list, may bombard that particular user with chat requests; most users, however, eventually reach a threshold of a number of open chat sessions that the user can effectively participate in. For example, one user may only have the ability to monitor and participate in a maximum of three chat conversations at the same time or even fewer if the one of the chat conversations is particularly intense. In addition, while many chat services include useful feature of alerting users to each request to participate in a chat session through a pop-up window, each pop-up window obscures a portion of the graphical user interface and as the number of chat session requests multiple more and more screen space is used up by chat session requests. While a user may select “do not disturb” to turn off all chat service communication without logging out or the user may select to block specific users by user identifier from initiating chat requests, these options provide limited control to a user attempting to block and filter chat communications to maintain a reasonable amount of concurrent chat communications with multiple users. In particular, current chat services are limited in blocking chat communications because “user A”, for example, only has the option to block specifically designated user identifiers, such as “user B”, or to block all chat communications, but not to select to block communications in a way that would allow the user to selectively manage the number of concurrently open chat sessions.

In view of the foregoing, it would be advantageous to provide a method, system, and program for enabling user selection of preferences for managing the number of concurrently open chat sessions. In particular, it would be advantageous to provide a method, system, and program for enabling a user to select or automatically selecting a first presence indicator for output to those other users currently in chat session communication with the particular user and a second presence indicator for output only to those users who monitor the presence of the particular user, but who are not currently participants in a chat session with the particular user. In addition, it would be advantageous for the second presence indicator, output to current non-participants, to block those users who are not currently participants in a chat session with the particular user from initiating a chat session with the particular user until conditions for the particular user change.

### SUMMARY OF THE INVENTION

Therefore, the present invention provides improved chat service and in particular provides an improved method, system, and program for limiting additional requests for chat sessions with a particular user who is already participating in a maximum number of chat sessions. Still more particularly, the present invention provides a method, system, and program for automatically limiting a particular user from receiving additional chat session requests by blocking those users not currently participating in a chat session with the particular user from initiating a new chat session with the particular user.

In particular, a number of concurrently open chat sessions between a particular user and users from a first selection of multiple users are detected, wherein the first selection of the multiple users and a remaining selection of the multiple users monitor a presence of the particular user through a presence indicator that indicates whether the particular user is available to participate in an additional chat session. Responsive to the number of concurrently open chat sessions exceeding a threshold for the particular user, updating the presence indicator of the particular user transmitted to the remaining selection of the multiple users to indicate a lack of availability for the additional chat session, but enabling the first selection of the multiple users to continue participating in the already open chat sessions with the particular user.

For purposes of updating the presence of the particular user, particular users may be excluded from the remaining selection of users. Further, in addition to determining whether to update the presence indicator of the particular user based on the number of concurrently open chat sessions, additional detected activity by the particular user may exceed the communication threshold and trigger the update to set the presence of the particular to indicate a lack of availability for the additional chat session to the remaining selection of users. Moreover, if a currently open chat session is closed and the number of concurrently open chat sessions no longer exceeds the communication threshold, the presence indicator of the particular user is updated to the remaining selection of users indicate a current availability of the particular user to receive an additional chat session request.

In one embodiment, a chat server facilitates the chat sessions through a chat service. A particular client system communicatively connected via a network to the chat server communicates a “non-participant” specified presence indicator to the chat server, wherein the particular client system facilitates the particular user accessing said chat service. The chat server controls output of the “non-participant” specified presence indicator to a first selection of client systems at which the remaining selection of users, not currently participating in chat sessions with the particular user, are logged in to the chat service. Additionally, the particular client system may communicate a “participant” specified presence indicator to the chat server. The chat server then controls output of the “participant” specified presence indicator a second selection of client systems at which the first selection of users, currently participating in chat sessions with the particular user, are logged in to the chat service.

In another embodiment, the chat service facilitates the chat sessions through a chat service, but the particular client system at which the particular user is logged on communicates at least one activity indicator to the chat server. The activity indicator may include multiple indicators of activity and inactivity by the particular user. In one example, the activity indicator specifies a total number of chat sessions participated in by the particular user across multiple chat services, not just the chat service facilitated by the chat server receiving the activity indicator. The chat server selects communication thresholds that apply to the particular user and determines whether the activity indicator exceeds the applicable communication thresholds. If the activity indicator exceeds the application communication threshold, then the chat server controls output of a presence indicator of lack of availability to the first selection of client systems at which those users currently not participating in chat sessions with the particular user are logged in to the chat service.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting a network environment for supporting chat communications;

FIG. 3 is a block diagram depicting examples of functional components of a chat agent for supporting chat communications;

FIG. 4 is a block diagram depicting examples of functional components within a chat server that enables chat service;

FIG. 5 is an illustrative chart depicting examples of chat activity response settings;

FIG. 6 is a flow diagram depicting the flow of data between users logged in at chat agents and a chat server for facilitating chat services and examples of the updates to presence indicators in the graphical user interface associated with each user;

FIG. 7 is a flow diagram depicting a flow of data between chat agents and a chat server for facilitating chat servers and examples of the updates to presence indicators in the graphical user interface associated with each user;

FIG. 8 is a high level logic flowchart depicting a process and program for controlling output of presence data and other activity information from a chat agent to a chat server; and

FIG. 9 is a high level logic flowchart depicting a process and program for controlling distribution of presence indicators from a chat server to chat agents logged into by users monitoring the presence of a particular user.

### DETAILED DESCRIPTION OF THE PREFERRED EMBODIMENT

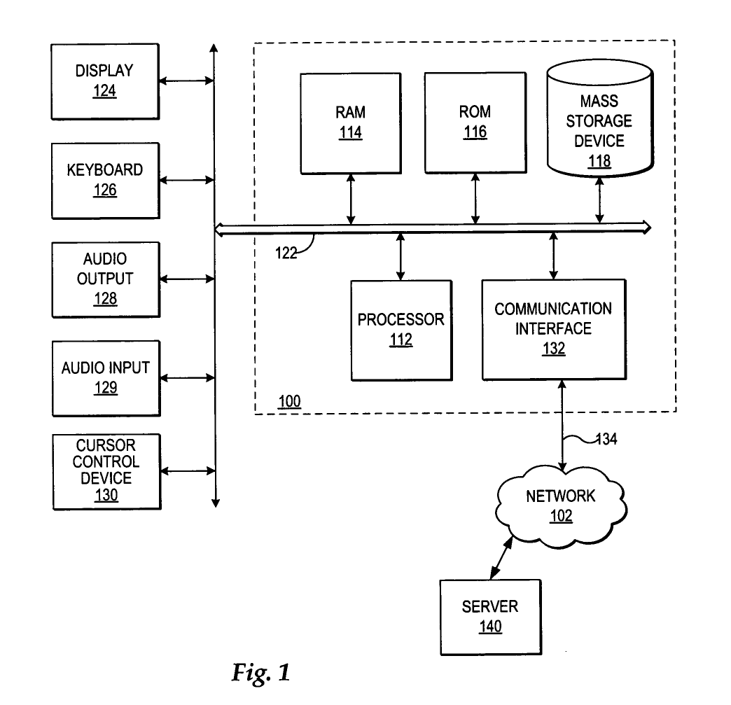

Referring now to the drawings and in particular to FIG. 1, there is depicted one embodiment of a system through which the present method, system, and program may be implemented. The present invention may be executed in a variety of systems, including a variety of computing systems and electronic devices.

Computer system 100 includes a bus 122 or other communication device for communicating information within computer system 100, and at least one processing device such as processor 112, coupled to bus 122 for processing information. Bus 122 preferably includes low-latency and higher latency paths that are connected by bridges and adapters and controlled within computer system 100 by multiple bus controllers. When implemented as a server system, computer system 100 typically includes multiple processors designed to improve network servicing power.

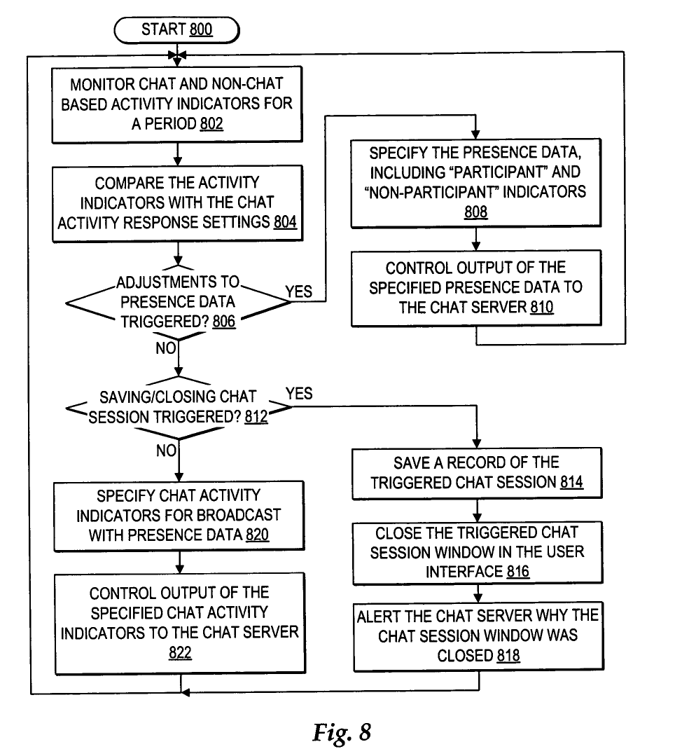

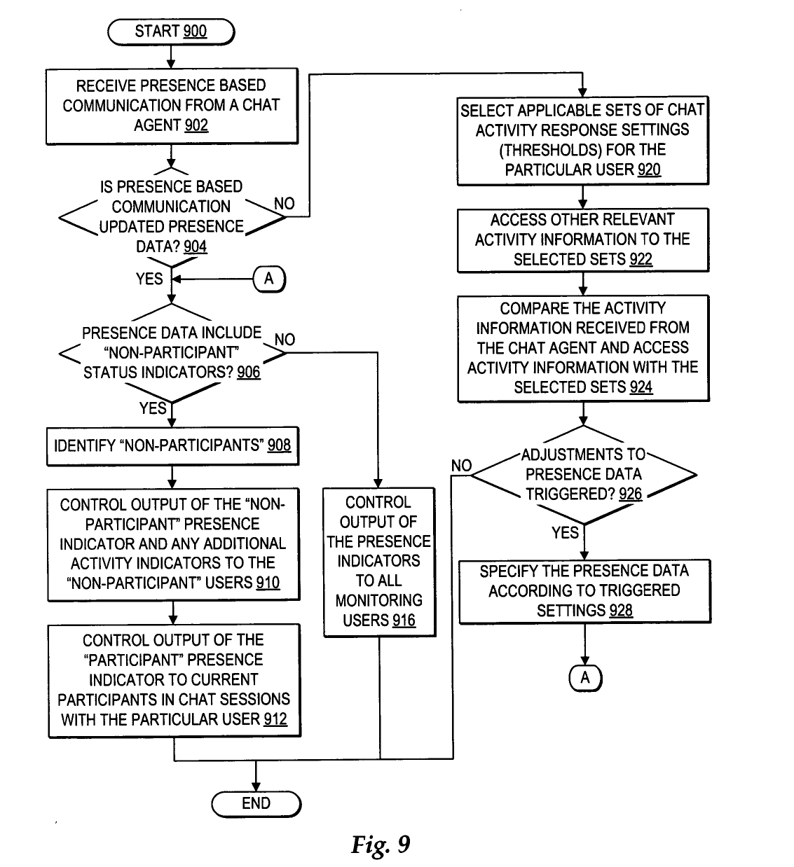

Processor 112 may be a general-purpose processor such as IBM's PowerPC™ processor that, during normal operation, processes data under the control of operating system and application software accessible from a dynamic storage device such as random access memory (RAM) 114 and a static storage device such as Read Only Memory (ROM) 116. The operating system preferably provides a graphical user interface (GUI) to the user. In a preferred embodiment, application software contains machine executable instructions that when executed on processor 112 carry out the operations depicted in the flowcharts of FIGS. 8 and 9 and other operations described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but will be understood to also be provided by an external device. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, the present invention may be downloaded as a computer program product, wherein the program instructions may be transferred from a remote computer such as a server 140 to requesting computer system 100 by way of data signals embodied in a carrier wave or other propagation medium via a network link 134 (e.g. a modem or network connection) to a communications interface 132 coupled to bus 122. Communications interface 132 provides a two-way data communications coupling to network link 134 that may be connected, for example, to a local area network (LAN), wide area network (WAN), or directly to an Internet Service Provider (ISP). In particular, network link 134 may provide wired and/or wireless network communications to one or more networks.

Network link 134 in turn provides data communication services through network 102. Network 102 may refer to the worldwide collection of networks and gateways that use a particular protocol, such as Transmission Control Protocol (TCP) and Internet Protocol (IP), to communicate with one another. Network link 134 and network 102 both use electrical, electromagnetic, or optical signals that carry digital data streams. The signals through the various networks and the signals on network link 134 and through communication interface 132, which carry the digital data to and from computer system 100, are exemplary forms of carrier waves transporting the information.

When implemented as a server system, computer system 100 typically includes multiple communication interfaces accessible via multiple peripheral component interconnect (PCI) bus bridges connected to an input/output controller. In this manner, computer system 100 allows connections to multiple network computers.

In addition, computer system 100 typically includes multiple peripheral components that facilitate communication. These peripheral components are connected to multiple controllers, adapters, and expansion slots coupled to one of the multiple levels of bus 122. For example, an audio output device 128 and audio input device 129 are connectively enabled on bus 122 for controlling audio outputs and inputs. A display device 124 is also connectively enabled on bus 122 for providing visual, tactile or other graphical representation formats and a cursor control device 130 is connectively enabled on bus 122 for controlling the location of a pointer within display device 124. A keyboard 126 is connectively enabled on bus 122 as an interface for user inputs to computer system 100. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

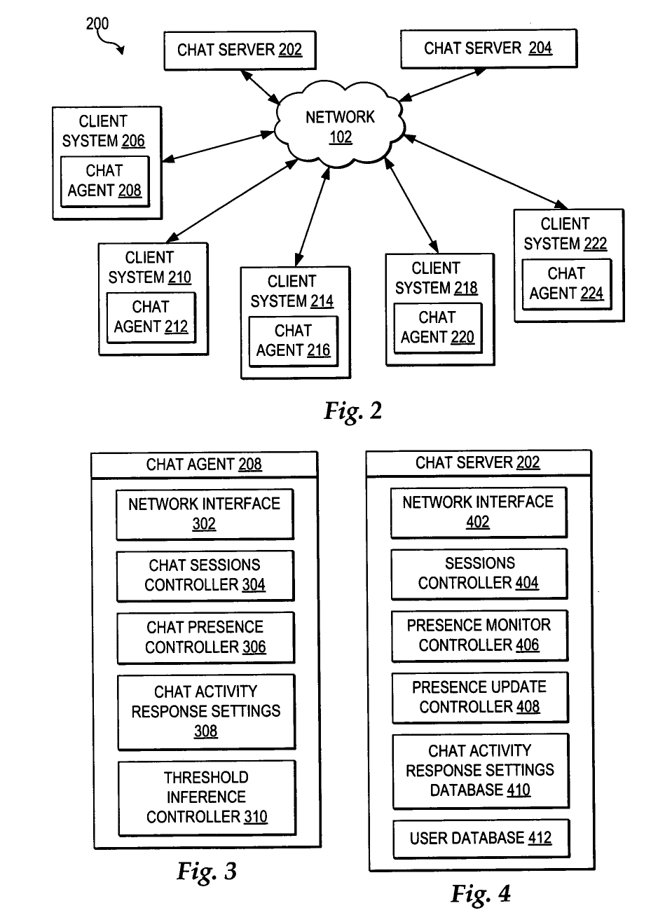

With reference now to FIG. 2, a block diagram depicts a network environment for supporting chat communications in accordance with the method, system, and program of the present invention. As illustrated, a distributed network 200 may include at least one server, such as chat server 202 or chat server 204, communicatively connected to network 102. In addition, distributed network 200 may include multiple client systems communicatively connected to network 102, such as client systems 206, 210, 214, 218, and 222. It will be understood that additional computing server and client systems may communicatively connect to network 102 within distributed network 200 for facilitating chat communications. Network 102 may include permanent connections such as wire or fiber optics cables and temporary connections made through telephone connections and wireless transmission connections, for example.

Chat servers 202 and 204 and client systems 206, 210, 214, 218, and 222 may be connected within distributed network 200 in conformance with different network architectures. For example, within a client-server architecture, distributed network 200 is the Internet and network 102 represents a worldwide collection of networks and gateways that the use the TCP/IP suite of protocols to communicate with each other; in another example, distributed network is an intranet and network 102 facilitates a local area network (LAN) or wide area network (WAN). Under the client-server architecture, when two systems communicatively connected to network 102 communicate, the client-server architecture defines the roles that each device plays. In particular, a device communicatively connected to network 102 is considered a client if the device uses chat services and is considered a server if the device provides chat services. While chat server 202 and chat server 204 are specifically described as providing chat services, either of chat server 202 and chat server 204 may also receive chat services in a client role. In addition, while client systems 206, 210, 214, 218, and 222 are specifically described as receiving services, any of client systems 206, 210, 214, 218, and 222 may also provide services in a server role. Additionally, while the present invention is described with emphasis upon a client-server architecture, within a peer-to-peer architecture, client systems 206, 210, 214, 218 and 222 may directly communicate with each other, in chat communications, via network 102.

In one embodiment, chat servers 202 and 204 facilitate chat communications between client systems via network 102. Chat servers 202 and 204 may each represent a different chat service provider or the same chat service provider. Additionally, chat servers 202 and 204 may each represent a public chat service provider or a private, in-house chat service provider.

Each of client systems 206, 210, 214, 218, and 222 may include a chat agent, such as chat agents 208, 212, 216, 220, and 224, respectively. A chat agent communicates between the client system and the chat server to facilitate chat communications and chat status updates. While chat agents 208, 212, 216, 220, and 224 are depicted as each associated with a particular client system, chat agents may be distributed across multiple systems in a distributed network and multiple client systems and server systems may share a single or multiple chat agents. Additionally, each of client systems 206, 210, 214, 218, and 222 may include multiple chat agents, where each chat agents supports chat communications via a different chat service provider.

In facilitating chat communications between client systems, chat servers 202 and 204 may support chat communications in multiple formats including, but not limited to, chat rooms, instant messaging, IRC, and text messaging via multiple types of media including, but not limited to, text, voice, graphics, and video. In addition, in facilitating chat communications between client systems, chat servers 202 and 204 may support monitoring the presence of each user and distributing the presence of each user to other users through the transmission of presence indicators. Further, according to an advantage, in facilitating chat communications between client systems, chat server 202 and 204 may support distributing different presence indicators for a particular user based on whether the other users monitoring the presence of the particular user are currently participating in a chat session with the particular user. The presence indicator transmitted to those users monitoring the presence of the particular user, but not currently participating in a chat session with the particular user, may block those users not already participating in a chat with the particular user from initiating a chat session with the particular user. In one embodiment, the chat agent executing on the client system receiving the presence indicator blocks a non-participating user from initiating a chat session request. In another embodiment, the chat server receiving the presence indicator blocks a non-participating user from initiating a chat session request. Further, the chat agent executing on the client system receiving a chat session request from a non-participating user after the blocking indicator is distributed may automatically block the chat session request from output.

It will be understood that for chat communications, a user may be identified by a user identifier in multiple forms including, but not limited to, an e-mail address, an instant messaging identifier, a chat name, a telephone number, or other electronic location identifier.

Referring now to FIG. 3, a block diagram depicts examples of functional components of a chat agent for supporting chat communications in accordance with the method, system, and program of the present invention. In particular, examples of functional components of chat agent 208 are depicted. The functional components of chat agent 208 may be implemented within multiple network architectural layers, depending on the client system, including, but not limited to, the network layer, the operating system layer, and the application layer. In addition, it will be understood that additional functional components may be included in chat agent 208 and that the functional components depicted may be performed by multiple client systems and may be distributed across multiple client and server systems. Further, it is important to note that chat agent 208 may support chat communications through a particular chat service provider or through multiple chat service providers.

For purposes of illustration, chat agent 208 may be described herein, in part, with reference to “user A”, where “user A” is the user logged on via chat agent 208 to chat services. It will be understood that chat agent 208 may facilitate log in for many different users, but for purposes of illustration, the user supported by chat agent 208 is “user A”.

As illustrated, chat agent 208 includes a network interface 302. Network interface 302 manages chat communication by chat agent 208 via the network sockets opened for supporting bi-directional communication between chat agent 208 and a chat server, such as chat server 202 or between chat agent 208 and another chat agent. It will be understood that network interface 302 may manage chat communications using multiple protocols, including protocols unique to communications between the chat agent and the chat server.

Chat agent 208 also includes a chat sessions controller 304. Chat sessions controller 304 includes a programming interface for enabling “user A” to select to communicate via a chat session with another user who is logged on and receiving chat session requests. Responsive to “user A” selecting to communicate with another user via a chat session, chat session controller 304 communicates the request to chat server 202 via network interface 302.

Additionally, chat sessions controller 304 handles received requests from other users requesting communication with “user A” via a chat session. Upon receipt of a request for communication with “user A” via a chat session, chat sessions controller 304 may alert “user A” to the request via an output interface accessible to “user A”. In one example, chat sessions controller 304 alerts “user A” to a request by adding a pop-up window to a graphical user interface, where the pop-up window indicates the identifier for the user requesting the chat session and the opportunity to accept or decline the request. In another example, chat sessions controller 304 alerts “user A” to a request by controlling output of a particular audible output indicating the request. For example, the audible output may include a voice announcement of the identifier of the user requesting the chat session. It will be understood that chat sessions controller 304 may enable “user A” to select a preferred output type to alert “user A” to new chat session requests.

In addition, chat agent 208 includes a chat presence controller 306. Chat presence controller 306 includes a programming interface for enabling “user A” to select a particular presence for broadcast to other users via chat server 202 and for controlling how the presence information for other users is output to “user A”. In one example, “user A” adds user identifiers to a buddy list, where the buddy list indicates those users whose presence “user A” automatically requests to monitor.

In one embodiment, chat presence controller 306 enables “user A” to select a particular presence by selecting from among multiple indicators of availability. In another example, chat presence controller 206 automatically designates a presence for “user A” by accessing monitored indicators of activity by “user A”. For example, in accessing monitored indicators of activity by “user A”, chat presence controller 306 may access the number of strokes per minute by “user A”, as monitored by the operating system, and automatically set the presence of “user A” to “away” if the number of strokes per minute indicates idleness for more than ten minutes.

According to an advantage, chat presence controller 306 may output presence data for “user A” to chat server 202, where the presence data includes multiple presence indicators specified for output to other users according to whether the other user monitoring the presence of “user A” is also currently participating in a chat session with “user A”. In particular, for purposes of illustration, those users currently participating in at least one chat session with “user A” are referred to as “participants” and those users that monitor the presence of “user A” but are not currently participating in a chat session with “user A” are referred to as “non-participants”. By enabling presence data to include multiple presence indicators, when chat session thresholds are reached, “non-participants” receive a presence indicator indicating lack of availability of “user A” and “participants” are allowed to continue in chat sessions with “user A”. It is important to note that “non-participants” may also include users who do not request to monitor the presence of “user A” and are not currently participating in a chat session with “user A”, but may attempt to request to chat with “user A” without seeing the presence of “user A”.

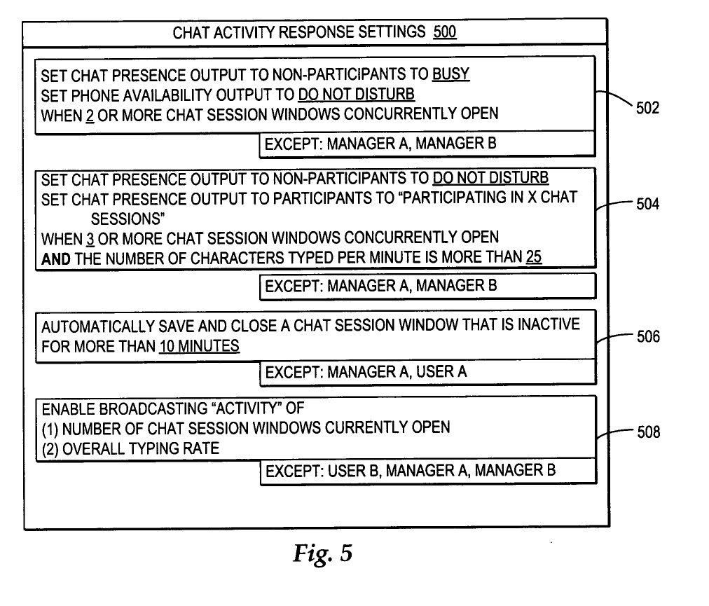

In one embodiment, “user A” specifies chat activity response settings 308 that specify the chat session thresholds for “user A” for filtering presence data output by chat presence controller 308. As will be further described with reference to FIG. 5, chat activity response settings 308 may designate thresholds for adjusting presence indicators to “non-participants” where the thresholds include the number of chat sessions currently open and other chat and non-chat based activity detected for “user A”. In addition, chat activity response settings 308 may include thresholds for closing an already open chat sessions and may include filtering specifications for output of the chat and non-chat based activity detected for “user A”. To detect chat and non-chat based activity, chat activity response settings 308 may include functional components that track activity or access tracked activity from the operating system or an application.

In another embodiment, “user A” specifically selects the different presence data for participants versus non-participants from a menu or other input interface. For example, a buddy list may include one pull-down menu for selecting a presence to output to participants and another pull-down menu for selecting a presence to output to non-participants.

In the two previously described embodiments where chat presence controller 308 controls output of presence data for “user A”, in one embodiment, the presence identifier directed to “participants” is labeled as such and the presence identifier directed to “non-participants” is labeled as such, where the chat server then determines those users who are considered “participants” and those users considered “non-participants” and distributes the correlating presence data. In another embodiment, the presence data may indicate the user identifiers of current participants. Further, in another embodiment, presence data may include presence data for “participants”, “non-participants”, and specific user identifiers for users who are exceptions to the “participant” or “non-participant” status.

In yet another embodiment, the chat and non-chat based activity detected by chat presence controller 308 may be passed to a chat server, such as chat server 202. Chat server 202 then compares the chat and non-chat based activity, such as the number of key strokes per minute entered by “user A” at a client system, with chat activity response settings and automatically selects the multiple presence indicators for participants and non-participants, as will be further described with reference to FIG. 4.

Further, chat agent 208 may include a threshold inference controller 310 that monitors chat and non-chat based activity for “user A”, tracks patterns of chat communications by “user A”, and infers threshold settings for “user A”. For example, in inferring threshold settings for “user A”, threshold interference controller 310 may infer the average maximum number of chat sessions that “user A” can realistically participate in and may interfere that the average maximum number changes dramatically if one of the participants is a particular user, such as “manager A”. In another example, threshold inference controller 310 may infer that “user A” is able to handle more concurrent chat sessions on average during a particular time of day, on a particular day of the week, or when logged on at a particular location or device.

With reference now to FIG. 4, a block diagram depicts examples of functional components within a chat server that enables chat service in accordance with the method, system, and program of the present invention. In particular, examples of functional components of chat server 202 are depicted. The functional components of chat server 202 for providing chat services may be implemented within multiple network architectural layers, depending on the server system, including, but not limited to, the network layer, the operating system layer, and the application layer. It will be understood, that additional functional components for facilitating chat services may be included in chat server 202 and that the functional components depicted may be performed by multiple disparate server systems or client systems and the functional components depicted may be distributed across multiple server systems and client systems.

As illustrated, chat server 202 includes a network interface 402. Network interface 402 manages the communication between the chat functional components through multiple open server sockets with multiple chat agents. It will be understood that the hardware interfaces of the server system or systems represented as chat server 202 may effect the settings of how network interfaces 402 supports chat services to chat agents via network 102. In addition, it will be understood that network interfaces 402 may support communications in different protocols including a single proprietary protocol and multiple disparate protocols.

As depicted, chat server 202 includes a user database 412. User database 412 includes the identifiers of users that subscribe to the chat service offered through chat server 202. A single user may register under one or more identifiers. In addition, a user may specify chat session format preferences, output preferences, and other preferences offered by the chat service.

In addition, chat server 202 includes a sessions controller 404. Chat session controller 404 facilitates the actual chat communication between chat agents through chat sessions in multiple chat formats. For example, sessions controller 404 may support chat room based chat sessions and instant messaging based chat sessions. Sessions controller 404 may restrict and format chat sessions for a particular user based on the chat session preferences associated with the user in user database 412.

Chat server 202 also includes a presence monitor controller 406 and a presence update controller 408. Presence monitor controller 406 determines the presence of each registered user in user database 412 and in particular monitors the specific presence of each user currently logged on to chat server 202 through a chat agent. Presence update controller 408 distributes presence data for users among the users registered in user database 412.

In one embodiment, presence monitor controller 406 detects presence data for “user A” that includes a presence identifier for “participants” and a separate presence identifier for “non-participants”. Presence monitor controller 406 adds the identifiers of those users who are “participants” to the presence data and passes the updated presence data to presence update controller 408. Presence update controller 408 detects those other users who monitor the presence of “user A”. Presence update controller 408 controls distribution of the presence identifier for “participants” to those users identified as participants and controls distribution of the presence identifier for “non-participants”to all other users who monitor the presence of “user A”.

In another embodiment, presence monitor controller 406 detects chat and non-chat based activity associated with “user A”. Presence monitor controller 406 may also detect chat and non-chat based activity associated with “user A”. For example, presence monitor controller 406 may query sessions controller 404 for the number of current chat sessions that “user A” is a participant within. In another example, presence monitor controller 406 may query an electronic calendar or a telecommunication provider for “user A” to access current scheduled activity and additional communications participated in by “user A”. Presence monitor controller 406 compares the activity for “user A” with all applicable chat activity response settings from chat activity response settings database 410 and determines presence data for “user A”, including “participant” and “non-participant” presence indicators. Chat activity response settings database 410 may include multiple sets of chat activity response settings, as will be further described with reference to FIG. 5, where multiple sets of chat activity response settings may apply to a single user. For example, chat activity response settings database 410 may include chat activity response settings specified by each user. In addition, chat activity response settings database 410 may include chat activity response settings specified for a group or users or for a type of users.

Referring now to FIG. 5, an illustrative chart depicts examples of chat activity response settings in accordance with the method, system, and program of the present invention. As illustrated, chat activity response settings 500 for a particular user include multiple settings relating to the activity of “user A”. As previously described, chat activity response settings 500 may be accessible to a chat agent, such as chat agent 208 through chat activity response settings 308 or to a chat server, such as chat server 202 through chat activity response settings database 410.

The activity of a current user may relate to chat and non-chat based communications by the current user via a computer and other electronic devices and may relate to the user interfacing with the hardware, software, and network accessibility of a computer and other electronic devices may be measured by the computer or other electronic device or by a server system, for example. In a first set of examples, “activity” may include the typing rate per chat session window, the overall typing rate per minute, the number of chat session windows currently open, the number of chat session windows currently inactive for more than a specified period of time, the number of application windows currently opened, the number of mouse clicks entered over a period of time, a number of browser windows open, the percentage of screen space used by open chat session windows, and other information about the activity level of a current user in the form of statistics about user interaction with a computer interface. In a second set of examples, “activity” may include a specific description of user interaction with a computer interface, such as the names of specific open application windows, names of specific open documents, names of specific web pages currently accessed, and other information about the activity level of a user in the form of specific use. It will be understood that “activity” may also include information collected from other applications, such as an electronic calendar and from other devices, such as from an electronic personal health monitoring device or from a global positioning system device.

In the example, one type of setting is an “activity” based condition for triggering a change in the presence indicator for “user A” for output to “non-participants”. For example, a first setting illustrated at reference numeral 502 designates that an “activity” based condition of “when 2 or more chat session windows are concurrently open” triggers the action of “set the presence indicator output to non-participants to BUSY” and “set phone availability output to DO NOT DISTURB”, with the exception of the users “manager A” and “manager B”.

In another example, a second setting illustrated at reference numeral 504 designates that an “activity” based condition of “when 3 or more chat session windows are concurrently open” and “the number of characters typed per minute is greater than 25” triggers the action of “set the presence indicator output to non-participants to DO NOT DISTURB”, with the exception of users “manager A” and “manager B”, and “set the presence indicator output to participants to PARTICIPANT IN X CHAT SESSIONS” where X is the number of current chat sessions including “user A”. It will be understood that in addition to the examples depicted, other “activity” based conditions may trigger a change in availability status of a current user output to other non-participating users.

User settings at reference numerals 502 and 504 in chat activity response settings 500 may translate into instructions such as:

while (true)
{

if (presence is not = do not disturb)
{

if ((number of chat windows > 2) && (characters typed per
minute > 25))

set presence = do not disturb for all non-participants,
except “manager A”
and “manager B”; participant in X chat sessions for all
participants, do not
disconnect those already connected, X is the number of
chat windows

}
else /*presence already set to do not disturb*/
{

if ((number of chat windows <3)

set presence = busy for all non-participants

}
count how many chat windows are open
take average of how many characters typed in last minute
sleep 5 seconds

}

In addition, in the example, another type of setting is a condition for triggering the automatic closure of a chat session. For example, a setting illustrated at reference numeral 506 designates that the chat agent is to automatically save and close a chat session window detected as inactive for more than ten minutes, except for a chat session with the either of the users “manager A” or “user A”. Other activity information that may be advantageous to include in a save and close setting includes the percentage of screen space used by chat session windows and whether inputs to the system overall are inactive. In particular, “activity” may include inactivity as related to an open chat session window or other open window within the user interface. It will be understood that in addition to the example depicted, other “activity” based conditions may trigger closing and saving chat session windows.

Further, in the example, another type of setting is the “activity” information that can be broadcast to other users who monitor the status of “user A”. For example, a setting illustrated at reference numeral 508 designates that in broadcasting detected “activity”, the broadcast may include the “number of chat session windows currently open” and “the overall typing rate”. It will be understood that in addition to the example depicted, “user A” may select other types of “activity” for broadcast and may select additional conditions for broadcasting “activity”. Further, as will be further described, other users may select to filter the “activity” information broadcast for “user A”.

It will be understood that, although not depicted, the chat agent or the chat server will facilitate a user interface through which a user may enter the settings specified within chat activity response settings 500.

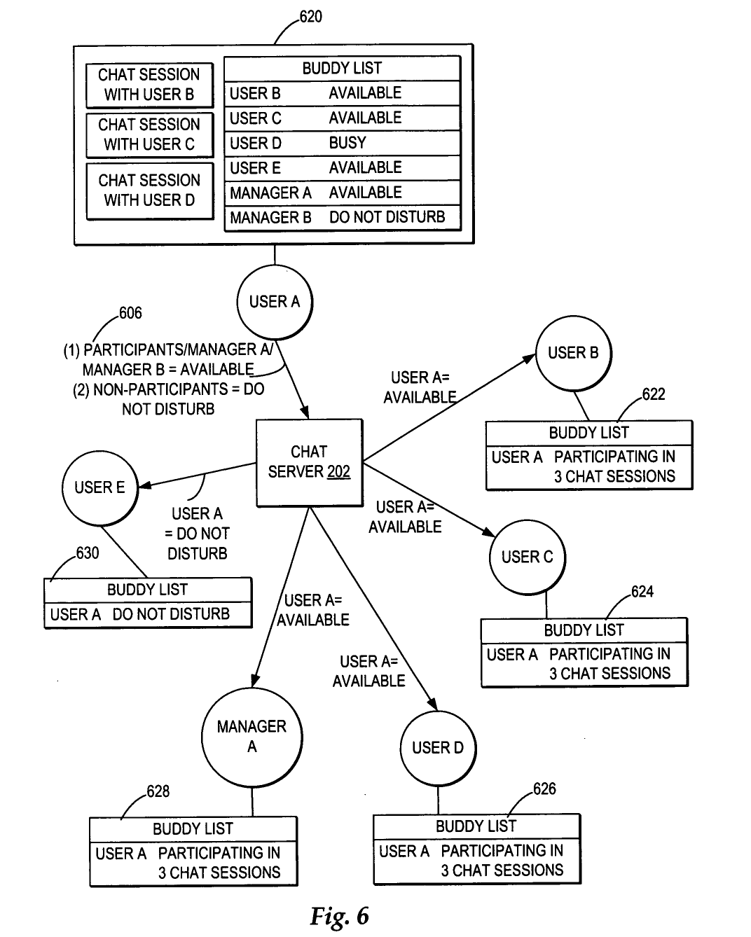

With reference now to FIG. 6, a flow diagram depicts the flow of data between users logged in at chat agents and a chat server for facilitating chat services and examples of the updates to presence indicators in the graphical user interface associated with each user in accordance with the method, system, and program of the present invention.

As illustrated, a user interface 620 indicates that “user A” is currently participating in chat sessions with “user B”, “user C”, and “user D”. Corresponding to chat activity response settings 500, presence data 606 is updated for “user A” because the condition of three chat session windows being are open triggers a presence indicator of “do not disturb” output to non-participants and “participating in 3 chat sessions” to participants. Therefore, as illustrated, presence data 606 for “user A” as communicated by a chat agent includes multiple presence indicators. A first presence indicator, designated for “participants/manager A/manager B” designates a presence of “participating in 3 chat sessions”. A second presence indicator, designated for “non-participants” designates a presence of “do not disturb”. It will be understood that, although not depicted, presence data 606 may also include additional specific “activity” information detected for “user A”.

Chat server 202 receives presence data 606 for “user A” and distributes the data to other users who monitor the presence of “user A”. In one example, chat server 202 detects those users who monitor the presence of “user A” and then detects a selection of the monitoring users who are currently participating in a chat session with “user A” or included as an exception to the “non-participant” status.

In the example depicted, “user B”, “user C”, and “user D” are currently participating in chat sessions with “user A” and therefore chat server 202 distributes the “participant” presence indicator from presence data 606 to “user B”, “user C”, and “user D”. A portion of the user interfaces accessible to “user B”, “user C”, and “user D”, where the portion displays a buddy list including the identifier for “user A” is illustrated, with the updated presence indicator, at reference numerals 622, 624, and 626, respectively.

In addition, “manager A” monitors the presence of “user A” and is an exception to the “non-participant” status and therefore chat server 202 distributes the “participant” presence indicator for presence data 606 to “manager A”. The portion of the user interface accessible to “manager A” where the portion displays a buddy list including the identifier for “user A” is illustrated, with the updated presence indicator, at reference numeral 628.

Further, “user E” monitors the presence of “user A”, however “user E” is not a participant in a chat session with “user A” or included as a “non-participant” status exception and therefore chat server 202 distributes the “non-participant” presence indicator for presence data 606 to “user E”. A portion of the user interface accessible to “user E” where the portion displays a buddy list including the identifier for “user E” is illustrated, with the updated “non-participant” presence indicator, at reference numeral 630.

It is important to note that in the example, presence data 606 is illustrated in a textual format that distinguishes between “participant” and “non-participant” presence indicators for purposes of illustration. The actual transmission format of presence data 606 may include tagging or other data structuring information.

It will be understood that, although not depicted, the presence indicators specified in presence data 606 may also include the additional “activity” information for “user A”. Presence data 606 may include specifications for chat server 202 to filter the broadcast of additional “activity” information for “user A”according to “participant” or “non-participant” status or other status. In addition, chat server 202 may filter the broadcast of additional “activity” information for “user A” according to preferences designated by each user receiving the presence indicator and other “activity” information for “user A”.

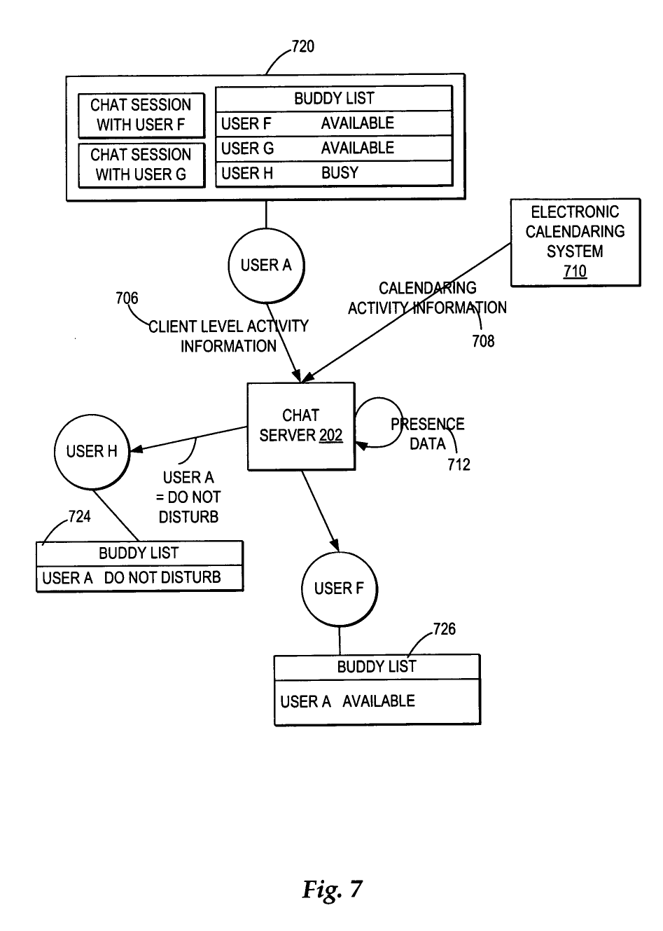

Referring now to FIG. 7, a flow diagram depicts a flow of data between chat agents and a chat server in accordance with the method, system, and program of the present invention. As illustrated, the client activity information 706 for “user A” as communicated by a chat agent to chat server 202 includes client level activity information, as described with reference to FIG. 5, but not a specific presence indicator. Additionally, calendaring activity information 708 for “user A” as accessed from an electronic calendaring system 710 includes activity information, as described with reference to FIG. 5, accessed from an additional electronic system.

Chat server 604 detects client activity information 706 and calendaring activity information 708 and determines presence data 712 for “user A” by filtering the activity through applicable chat activity response settings. Chat server 202 then controls output of presence data 712 to users monitoring the presence of “user A”. In addition, chat server 202 may determine which chat sessions to automatically save and close based on client activity information 706 and calendaring activity 708 and chat server 202 may determine which activity information to output to other users in addition with the output of a presence indicator for “user A”.

In the example, chat server 202 determines presence data 712 based on the number of overall chat sessions received in client activity information 706 and the chat conference scheduled for “user A” in calendaring activity information 708. In one example, the chat activity response settings for a group of employees including “user A” may specify a threshold of one open chat session, regardless of the chat service, in addition to a chat session opened for the chat conference appointment.

In addition, in the example, chat server 202 detects that “user A” is participating in chat sessions with “user F” and “user G”, as further indicated at reference numeral 720 in a display interface accessible to “user A”. The chat session with “user F” is the chat conference appointment chat session via the chat service facilitated by chat server 202. The chat session with “user G” is an additional chat session opened through another chat service. Chat server 202 also detects that “user H” is not participating in a chat session with “user A”, but monitors the presence of “user A”. Chat server 604 updates the presence indicator output to the “non-participant” to “do not disturb” as indicated in the portion of the user interface accessible to “user H” that indicates the presence of “user A” at reference numeral 724, but does not update the presence indicator output to the “participant” as indicated in the portion of the user interface accessible to “user F” as indicated at reference numeral 726.

Referring now to FIG. 8, a high level logic flowchart depicts a process and program for controlling output of presence data and other activity information from a chat agent to a chat server in accordance with the method, system, and program of the present invention. In the embodiment, the process starts at block 800 and thereafter proceeds to block 802. Block 802 depicts monitoring chat and non-chat based activity indicators, both statistical and specific, for a particular user for a particular period of time. Next, block 804 illustrates comparing the activity indicators with chat activity response settings for a particular user. Block 806 depicts a determination whether adjustments to presence data are triggered in the chat activity response settings by the activity indicators. If adjustments to presence data are triggered, then the process passes to block 808. Block 808 illustrates specifying the presence data, including other activity information in addition to “participant” and “non-participant” status based presence indicators and status exceptions. Next, block 810 depicts controlling output of the presence data to the chat server, and the process returns to block 802.

Returning to block 806, if an adjustment to presence data is not triggered, then the process passes to block 812. Block 812 depicts a determination whether saving and closing a chat session is triggered. If saving and closing a chat session is triggered, then the process passes to block 814. Block 814 illustrates saving a record of a triggered chat session window. Next, block 816 depicts closing the triggered chat session window in the user interface and block 818 depicts alerting the chat server that the chat session window is closed. Then, the process passes to block 820.

Returning to block 812, if closing a chat session is not triggered, the process then passes to block 820. Block 820 depicts specifying, according to the chat activity response settings, the activity indicators to be broadcast to other users. Next, block 822 illustrates controlling output of the specified activity indicators to the chat server, and the process returns to block 802.

It is important to note that the process and program described with reference to FIG. 8 are based on the chat agent having access to chat activity response settings for a particular user. In an alternate embodiment, the chat agent may control output of the activity indicators to the chat server, where the chat server has access to the chat activity response settings and controls responses to the activity indicators based on the chat activity response settings. In addition, in an alternate embodiment, a user may select, via a user interface, a “participant” presence indicator and “non-participant” presence indicator, triggering the process starting at blocks 808 and 810, with output of the selected presence indicators.

With reference now to FIG. 9, a high level logic flowchart depicts a process and program for controlling distribution of presence indicators from a chat server to chat agents logged into by users monitoring the presence of a particular user in accordance with the method, system, and program of the present invention. In the embodiment, the process starts at block 900 and thereafter proceeds to block 902. Block 902 depicts receiving presence based communication from a chat agent logged into by a particular user, also referred to throughout the specification as “user A”. Block 904 illustrates a determination whether the presence based communication is updated presence data for the particular user. If the presence based communication is updated presence data for the particular user, then the process passes to block 906.

Block 906 depicts a determination whether the presence data includes presence indicators based on “participant” and “non-participant” status. If the presence data does not include presence indicators based on “participant” and “non-participant”, then the process passes to block 916. Block 916 depicts controlling output of the presence indicator to all monitoring users and responding to the presence indicator update, and the process ends. Otherwise, at block 906, if the presence data includes presence indicators based on “participant” and “non-participant” status, then the process passes to block 908. Block 908 illustrates a determination of those users monitoring the presence of the particular user but not currently participants in a chat session with the particular user and not included as exceptions. Next, block 910 depicts controlling output of the “non-participant” presence indicator and any additional activity information to the non-participant monitoring users. Thereafter, block 912 illustrates controlling output of the “participant” presence indicator and any additional activity information to the participating users, and the process ends. It is important to note that one of the types of presence indicators is “do not disturb” or other indicator that designates that the user is not to be disturbed by chat communications. When the “do not disturb” indicator is received as a “non-participant” presence indicator, then the currently open chat sessions are not affected, non-participant users are blocked from initiating new chat sessions with the particular user.

Returning to block 904, if the presence based communication is not updated presence data for the particular, then the presence based communication is activity information for the particular user and the process passes to block 920. Block 920 depicts determining applicable sets of chat activity response settings for the particular user. Next, block 922 illustrates accessing other relevant activity information for the particular user as indicated in the applicable sets of chat activity response settings. Thereafter, block 924 depicts comparing the activity information received from a chat agent and accessed from other systems with the applicable sets of chat activity response settings. Next block 926 illustrates a determination whether adjustments to presence data are triggered in any of the applicable sets of chat activity response settings by the detected activity. If adjustments to presence data are triggered, then the process passes to block 928. Block 928 illustrates specifying the presence data, including other activity information in addition to “participant” and “non-participant” status based presence indicators and status exceptions and the process passes to block 906. Although not depicted, the comparison of the activity information with the applicable sets of chat activity response settings may also trigger steps of saving and closing chat sessions.

It is important to note that the process and program of FIG. 9 are based in presence determination and updates being triggered by a presence based communication from a chat agent, however, in an alternate embodiment, communications from other systems with activity information associated with the particular user may trigger presence determination and updates by a chat server. In addition, in an alternate embodiment, chat server may periodically initiate presence determination and updates independent of communications from a chat agent.

While the invention has been particularly shown and described with reference to a preferred embodiment, it will be understood by those skilled in the art that various changes in form and detail may be made therein without departing from the spirit and scope of the invention.

What is claimed is:

1. A method for limiting chat session requests received by a particular user from among a plurality of users already participating in a plurality of chat sessions, in at least one computer system in communication with a network, wherein said at least one computer system comprises at least one from among a chat server that facilitates said plurality of chat sessions between a plurality of client systems logged onto by said plurality of users and a particular client system from among a plurality of client systems communicatively connected to said chat server logged onto by said particular user from among said plurality of users, comprising:
detecting, at said computer system, a number of said plurality of chat sessions each concurrently open between said particular user and at least one user from among a first selection of said plurality of users, wherein said first selection of said plurality of users and a remaining selection of said plurality of users monitor a presence of said particular user by receiving a presence indicator of said particular user that indicates whether said particular user is available to participate in an additional chat session; and
responsive to said number of said plurality of chat sessions exceeding a communication threshold for said particular user, updating said presence indicator of said particular user transmitted by said computer system to said remaining selection of said plurality of users to indicate a lack of availability for said additional chat session, wherein said first selection of said plurality of users are enabled to continue in said plurality of chat sessions with said particular user.

2. The method according to claim 1 for limiting chat session requests received by a particular user, wherein updating said presence indicator of said particular user transmitted by said computer system to said remaining selection of said plurality of users to indicate a lack of availability for said additional chat session further comprises:
receiving, at said chat server, a first presence indicator from said particular client system for said particular user, wherein said first presence indicator is specified for output to only said remaining selection of said plurality of users; and
controlling transmission from said chat server of said first presence indicator to a first selection of said plurality of client systems, wherein said remaining selection of said plurality of users are each currently logged in via one of said first selection of said plurality of client systems.

3. The method according to claim 2 for limiting chat session requests received by a particular user, further comprising:
receiving, at said chat server, a second presence indicator from said particular client system for said particular user, wherein said second presence indicator is specified for output to only said first selection of said plurality of users to indicate continued availability; and
controlling output from said chat server of said second presence indicator to a second selection of said plurality of client systems via said network, wherein said first selection of said plurality of users are currently logged in at said second selection of said plurality of client systems.

4. The method according to claim 1 for limiting chat session requests received by a particular user, wherein updating said presence indicator of said particular user transmitted by said computer system to said remaining selection of said plurality of users to indicate a lack of availability for said additional chat session further comprises:
receiving, at said chat server, at least one activity indicator transmitted from said particular client system for said particular user, wherein said at least one activity indicator specifies a total number of chat sessions participated in by said particular user across a plurality of chat services that facilitate chat sessions; and
selecting at least one particular communication threshold applicable to said particular user from among a plurality of communication threshold settings accessible to said chat server;
comparing said at least one activity indicator with said at least one particular communication threshold; and
responsive to said at least one activity indicator exceeding said particular communication threshold, controlling transmission of said presence indicator of lack of availability to a selection of said plurality of client systems, wherein said remaining selection of said plurality of users are each currently logged on at one of said selection of said plurality of client systems.

5. The method according to claim 1 for limiting chat session requests received by a particular user, wherein updating said presence indicator of said particular user transmitted by said computer system to said remaining selection of said plurality of users to indicate a lack of availability for said additional chat session, wherein said first selection of said plurality of users are enabled to continue in said plurality of chat sessions with said particular user, further comprises:
detecting at least one excluded user from among said remaining selection of said plurality of users, wherein said at least one excluded user is specifically excluded by said particular user from receiving said presence indicator indicating said lack of availability; and
excluding said at least one excluded user from said remaining selection of said plurality of users when updating said presence indicator of said particular user transmitted by said computer system to said remaining selection of said plurality of users to indicate said lack of availability for said additional chat session.

6. The method according to claim 1 for limiting chat session requests received by a particular user, further comprising:
detecting at least one activity indicator for said particular user, wherein said activity indicator is a measure of interaction by said particular user with said particular client system through which said particular user participates in said plurality of chat sessions via said network; and
responsive to said at least one activity indicator and said number of said plurality of chat sessions exceeding said communication threshold, updating said presence indicator of said particular user transmitted by said computer system to said remaining selection of said plurality of users to indicate said lack of availability for said additional chat session.

7. The method according to claim 1 for limiting chat session requests received by a particular user, further comprising:
responsive to detecting a particular chat session from among said plurality chat sessions close and said number of said plurality of chat sessions not exceeding said communication threshold, updating said presence indicator of said particular user transmitted by said computer system to said remaining selection of said plurality of users to indicate a current availability for said additional chat session.

8. A system for limiting chat session requests received by a particular user already participating in a plurality of chat sessions, comprising:
at least one computer system in communication with a network, wherein said at least one computer system comprises at least one from among a chat server that facilitates a plurality of chat sessions between a plurality of client systems logged onto by a plurality of users and a particular client system from among a plurality of client systems communicatively connected to said chat server logged onto by a particular user from among said plurality of users;
said at least one computer system further comprising:
means for detecting a number of said plurality of chat sessions each concurrently open between said particular user and at least one user from among a first selection of said plurality of users, wherein said first selection of said plurality of users and a remaining selection of said plurality of users monitor a presence of said particular user by receiving a presence indicator of said particular user that indicates whether said particular user is available to participate in an additional chat session; and
means, responsive to said number of said plurality of chat sessions exceeding a communication threshold for said particular user, for updating said presence indicator of said particular user transmitted by said computer system to said remaining selection of said plurality of users to indicate a lack of availability for said additional chat session, wherein said first selection of said plurality of users are enabled to continue in said plurality of chat sessions with said particular user.

9. The system according to claim 8 for limiting chat session requests received by a particular user, wherein said means for updating said presence indicator of said particular user transmitted by said computer system to said remaining selection of said plurality of users to indicate a lack of availability for said additional chat session further comprises:
means for receiving, at said chat server, a first presence indicator from said particular client system for said particular user, wherein said first presence indicator is specified for transmission to only said remaining selection of said plurality of users; and
means for controlling transmission from said chat server of said first presence indicator to a first selection of said plurality of client systems, wherein said remaining selection of said plurality of users are each currently logged in via one of said first selection of said plurality of client systems.

10. The system according to claim 9 for limiting chat session requests received by a particular user, further comprising:
means for receiving, at said chat server, a second presence indicator from said particular client system for said particular user, wherein said second presence indicator is specified for transmission to only said first selection of said plurality of users to indicate continued availability; and
means for controlling transmission from said chat server of said second presence indicator to a second selection of said plurality of client systems via said network, wherein said first selection of said plurality of users are currently logged in at said second selection of said plurality of client systems.

11. The system according to claim 8 for limiting chat session requests received by a particular user, wherein said means for updating said presence indicator of said particular user transmitted by said computer system to said remaining selection of said plurality of users to indicate a lack of availability for said additional chat session further comprises:
means for receiving, at said chat server, at least one activity indicator from said particular client system for said particular user, wherein said at least one activity indicator specifies a total number of chat sessions participated in by said particular user across a plurality of chat services that facilitate chat sessions; and
means for selecting at least one particular communication threshold applicable to said particular user from among a plurality of communication threshold settings accessible to said chat server;
means for comparing said at least one activity indicator with said at least one particular communication threshold; and
means, responsive to said at least one activity indicator exceeding said particular communication threshold, for controlling transmission of said presence indicator indicating said lack of availability to a selection of said plurality of client systems, wherein said remaining selection of said plurality of users are each currently logged on at one of said selection of said plurality of client systems.

12. The system according to claim 8 for limiting chat session requests received by a particular user, wherein said means for updating said presence indicator of said particular user transmitted by said computer system to said remaining selection of said plurality of users to indicate a lack of availability for said additional chat session, wherein said first selection of said plurality of users are enabled to continue in said plurality of chat sessions with said particular user, further comprises:
means for detecting at least one excluded user from among said remaining selection of said plurality of users, wherein said at least one excluded user is specifically excluded by said particular user from receiving said presence indicator indicating said lack of availability; and
means for excluding said at least one excluded user from said remaining selection of said plurality of users when updating said presence indicator of said particular user transmitted by said computer system to said remaining selection of said plurality of users to indicate said lack of availability for said additional chat session.

13. The system according to claim 8 for limiting chat session requests received by a particular user, further comprising:
means for detecting at least one activity indicator for said particular user, wherein said activity indicator is a measure of interaction by said particular user with said particular client system through which said particular user participates in said plurality of chat sessions via said network; and
means, responsive to said at least one activity indicator and said number of said plurality of chat sessions exceeding said communication threshold, for updating said presence indicator of said particular user transmitted by said computer system to said remaining selection of said plurality of users to indicate said lack of availability for said additional chat session.

14. The system according to claim 8 for limiting chat session requests received by a particular user, further comprising:
means, responsive to detecting a particular chat session from among said plurality chat sessions close and said number of said plurality of chat sessions not exceeding said communication threshold, for updating said presence indicator of said particular user transmitted by said computer system to said remaining selection of said plurality of users to indicate a current availability for said additional chat session.

15. A program for limiting chat session requests received by a particular user already participating in a plurality of chat sessions, said program embodied in a computer-readable medium, said program comprising computer-executable instructions which cause a computer to perform the steps of:
detecting a number of a plurality of chat sessions each concurrently open between a particular user and at least one user from among a first selection of a plurality of users via a network, wherein said first selection of said plurality of users and a remaining selection of said plurality of users monitor a presence of said particular user by receiving a presence indicator of said particular user that indicates whether said particular user is available to participate in an additional chat session; and
responsive to said number of said plurality of chat sessions exceeding a communication threshold for said particular user, updating said presence indicator of said particular user transmitted to said remaining selection of said plurality of users to indicate a lack of availability for said additional chat session, wherein said first selection of said plurality of users are enabled to continue in said plurality of chat sessions with said particular user.

16. The program according to claim 15 for limiting chat session requests received by a particular user, wherein updating said presence indicator of said particular user transmitted to said remaining selection of said plurality of users to indicate a lack of availability for said additional chat session further comprises:
receiving a first presence indicator from a particular client system logged onto by said particular user, wherein said particular client system is communicatively connected to said network, wherein said first presence indicator is specified for transmission to only said remaining selection of said plurality of users; and
controlling transmission of said first presence indicator to a first selection of a plurality of client systems communicatively connected to said network, wherein said remaining selection of said plurality of users are each currently logged in via one of said first selection of said plurality of client systems.

17. The program according to claim 15 for limiting chat session requests received by a particular user, wherein updating said presence indicator of said particular user transmitted to said remaining selection of said plurality of users to indicate a lack of availability for said additional chat session further comprises:
receiving at least one activity indicator from a particular client system logged onto by said particular user, wherein said particular client is communicatively connected to said network, wherein said at least one activity indicator specifies a total number of chat sessions participated in by said particular user across a plurality of chat services that facilitate chat sessions; and
selecting at least one particular communication threshold applicable to said particular user from among a plurality of communication threshold settings;
comparing said at least one activity indicator with said at least one particular communication threshold; and
responsive to said at least one activity indicator exceeding said particular communication threshold, controlling output of said presence indicator indicating said lack of availability to a selection of a plurality of client systems communicatively connected to said network, wherein said remaining selection of said plurality of users are each currently logged on at one of said selection of said plurality of client systems.

18. The program according to claim 15 for limiting chat session requests received by a particular user, wherein updating said presence indicator of said particular user transmitted to said remaining selection of said plurality of users to indicate a lack of availability for said additional chat session, wherein said first selection of said plurality of users are enabled to continue in said plurality of chat sessions with said particular user, further comprises:
detecting at least one excluded user from among said remaining selection of said plurality of users, wherein said at least one excluded user is specifically excluded by said particular user from receiving said presence indicator indicating lack of availability; and
excluding said at least one excluded user from said remaining selection of said plurality of users when updating said presence indicator of said particular user transmitted by said computer system to said remaining selection of said plurality of users to indicate said lack of availability for said additional chat session.

19. The program according to claim 15 for limiting chat session requests received by a particular user, further comprising the steps of:
detecting at least one activity indicator for said particular user, wherein said activity indicator is a measure of interaction by said particular user with a particular client system through which said particular user participates in said plurality of chat sessions via said network; and
responsive to said at least one activity indicator and said number of said plurality of chat sessions exceeding said communication threshold, updating said presence indicator of said particular user transmitted to said remaining selection of said plurality of users to indicate said lack of availability for said additional chat session.

20. The program according to claim 15 for limiting chat session requests received by a particular user, further comprising the step of:
responsive to detecting a particular chat session from among said plurality chat sessions close and said number of said plurality of chat sessions not exceeding said communication threshold, updating said presence indicator of said particular user transmitted to said remaining selection of said plurality of users to indicate a current availability for said additional chat session.
